(19) United States
(12) Patent Application Publication
(10) Pub. No.: US 2013/0162039 A1
(43) Pub. Date: Jun. 27, 2013

(54) SYSTEM AND METHOD OF CONTROLLING OPERATION OF ELECTRIC DEVICE

(71) Applicants: Shinya Naoi, Tokyo (JP); Yasuhiro Noro, Tokyo (JP); Toshimitsu Kumazawa, Kanagawa (JP)

(72) Inventors: Shinya Naoi, Tokyo (JP); Yasuhiro Noro, Tokyo (JP); Toshimitsu Kumazawa, Kanagawa (JP)

(21) Appl. No.: 13/713,843

(22) Filed: Dec. 13, 2012

(30) Foreign Application Priority Data
Dec. 22, 2011 (JP) 2011281944

(51) Int. Cl. H02J 4/00

(52) U.S. Cl. CPC H02J 4/00
USPC 307/31

(57) ABSTRACT

A system for controlling an electric device operation includes a plurality of electric devices managed by a consumer associated with a power system and a plurality of control devices for controlling an operation of the electric devices. The system includes an operation time calculation unit configured to calculate a start time of an operation of increasing or decreasing power received from the plurality of electric devices based on a control command for requesting an increase or decrease of power received from the power system such that the start time is different for each of the electric devices. Each of the control devices executes an operation of increasing or decreasing reception power at an operation start time different for each of the electric devices as a result of calculation of the calculation unit.

### CROSS-REFERENCE TO RELATED APPLICATION(S)

This application is based upon and claims the benefit of priority from Japan Patent Application(s) No. 2011-281944, filed on Dec. 22, 2011, the entire contents of which are incorporated herein by reference.

### TECHNICAL FIELD

The present disclosure relates to a system and method for controlling an operation of an electric device intended for various devices, apparatuses, and systems.

### BACKGROUND

Recently, the introduction of a photovoltaic power generation is in progress for the purpose of reducing CO₂ emissions or the like. The photovoltaic power generation, which is dependent upon weather, has characteristics in which an output thereof cannot be controlled. Such characteristics imply that there is a possibility that unused power in excess of the level of demand is generated, in particular, on holidays or days of rest in the spring and autumn in which power demand is low.

In such a case, there is an unbalance between supply and demand of power and frequency is increased resulting in an operation of a frequency relay, potentially creating an extensive power failure. As a countermeasure, a method of restraining an output of photovoltaic generation or charging the surplus in a battery has been considered.

Another countermeasure may include a method of operating a load of a consumer according to a request or command from a power system operator to thereby increase power demand.

Conversely, in a situation in which the available power supply is in shortage, if demand surpasses power supply capabilities, frequency is reduced resulting in an operation of a frequency relay, potentially creating an extensive power failure. In such a case, a method of stopping electric devices to thereby reduce demand of consumers may also be considered.

### SUMMARY

The present disclosure provides some embodiments of a system for controlling an operation of an electric device and an operation method which are capable of restraining electric devices from responding simultaneously and restraining the electric devices to a variation at which a generator can respond, thereby restraining the degradation of power quality.

According to one embodiment of the present disclosure, there is provided a system for controlling an operation of an electric device comprising a plurality of electric devices managed by a consumer associated with a power system and a plurality of control devices for controlling an operation of the electric devices, the system comprising: an operation time calculation unit configured to calculate a start time of an operation of increasing or decreasing power received from the plurality of electric devices based on a control command for requesting an increase or decrease of power received from the power system such that the start time is different for each of the electric devices, wherein each of the control devices executes an operation of increasing or decreasing reception power at an operation start time different for each of the electric devices as a result of calculation of the calculation unit.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is block diagram showing an overall configuration of a first embodiment.

FIG. 2 is a block diagram of a consumer management device and a load control device in the first embodiment.

FIG. 3 is a graph showing a load change of a related art.

FIG. 4 is a graph showing a load change of the first embodiment.

FIG. 5 is a flow chart illustrating processing of the first embodiment.

FIG. 6 is a graph showing a first example of an operation initiation time.

FIG. 7 is a graph showing a second example of an operation initiation time.

FIG. 8 is a graph showing a third example of an operation initiation time.

FIG. 9 a graph showing a first example of an operation time interval.

FIG. 10 a graph showing a second example of an operation time interval.

FIG. 11 a graph showing a third example of an operation time interval.

FIGS. 12A to 12C are views showing a plurality of methods for releasing a power limitation command.

FIG. 13 is a block diagram showing the configuration of a second embodiment.

FIG. 14 is a block diagram of a consumer management device and a load control device in the second embodiment.

FIG. 15 is a flow chart illustrating an example of processing of the second embodiment.

FIG. 16 is a flow chart illustrating another example of processing of the second embodiment.

FIG. 17 is a block diagram showing the configuration of a third embodiment.

FIG. 18 is a block diagram of a system management device and a load control device in the third embodiment.

FIG. 19 is a flow chart illustrating processing of the third embodiment.

FIG. 20 is a block diagram showing the configuration of a fourth embodiment.

FIG. 21 is a block diagram of a load control device in the fourth embodiment.

FIG. 22 is a block diagram showing the configuration of a fifth embodiment.

FIG. 23 is a block diagram of a consumer management device and a load control device in the fifth embodiment.

FIG. 24 is a graph showing an example of processing of the fifth embodiment.

FIG. 25 is a graph showing another example of processing of the fifth embodiment.

FIG. 26 is a block diagram showing the configuration of a sixth embodiment.

FIG. 27 is a block diagram of a consumer management device, a load control device, and a generation device control device in the sixth embodiment.

FIG. 28 is a graph showing an example of a load and a generator output in the sixth embodiment.

FIG. 29 is a graph showing another example of a load and a generator output in the sixth embodiment.

FIG. 30 is a block diagram of a consumer management device and a load control device in a seventh embodiment.

FIG. 31 is a graph showing a method of calculating an operation time in the seventh embodiment.

### DETAILED DESCRIPTION

### 1. First Embodiment

### (1) Configuration

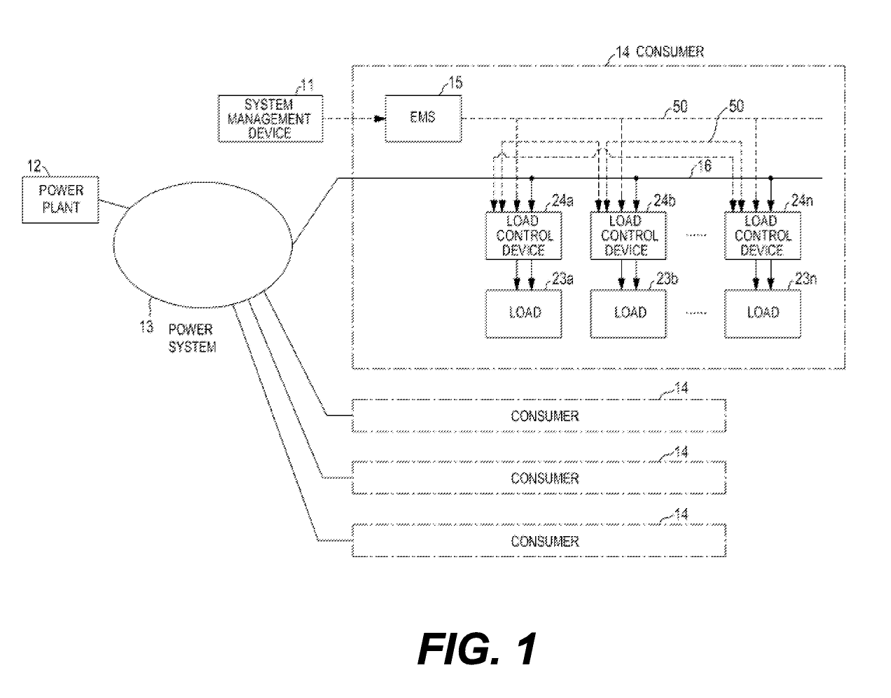

FIG. 1 is a block diagram showing an overall configuration of the present embodiment. In the present embodiment, a system management device 11 manages and operates one or more power plants 12, a power system 13, and a consumer 14 associated with the power system 13. The consumer 14 includes an energy management system (EMS) 15 connected to the system management device 11 by a communication line 50.

The system management device 11 may be a device such as a control panel operated by a management operator or may be management software provided in a computer of the control panel. The consumer 14 may be a single consumer or a group of consumers of a certain range of area, a building, an apartment complex, a plant, as long as the consumer(s) is/are managed by the system management device 11.

In order to receive electricity from power system 13, the consumer 14 has a power line 16 laid, and loads 23a-23n, such as electric devices, are connected to the power line 16 to use electricity. The respective loads 23a-23n include each load control device 24a-24n having a communication/computation function, and the load control devices 24a-24n are connected to different load control devices 24a-24n or the EMS 15 by way of the communication line 50. The load control device 24a-24n may be installed in the loads 23a-23n or may be separately installed.

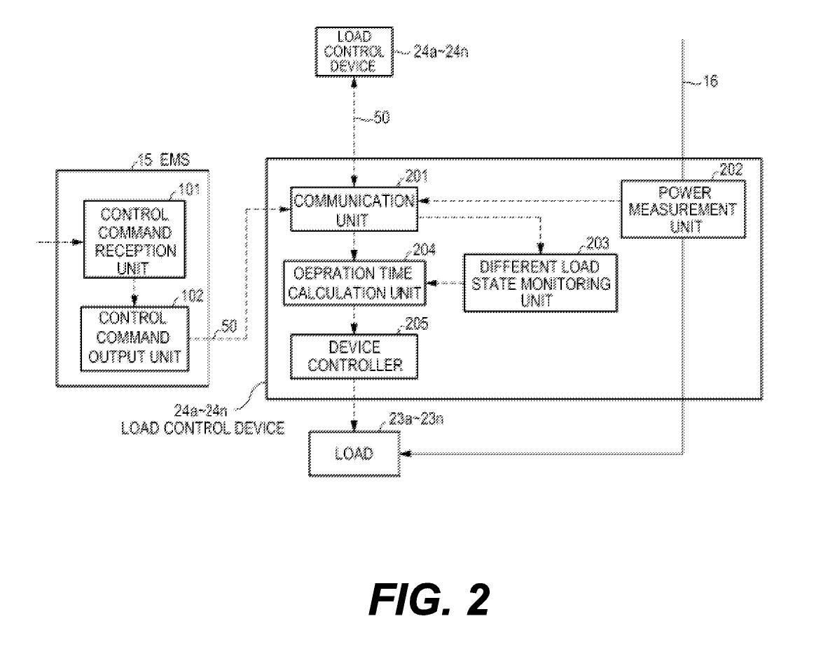

FIG. 2 is a block diagram showing the configuration of the EMS 15 and the load control devices 24a-24n. As shown in FIG. 2, the EMS 15 includes a reception unit 101 for receiving a command from the system management device 11 and an output unit 102 for transmitting a control command with respect to each load control device 24a-24n. Meanwhile, the EMS 15 is not limited to the configuration in which the reception unit 101 and the output unit 120 are integrated. For example, the reception unit 101 may allow the consumer 14 to receive a control command from the system management device 11 by means of a phone, a facsimile, a mail, or the like therethrough, and the output unit 102 may allow the consumer 14 to manually input a control command by using a manipulation panel or the like installed in each load control device 24a-24n.

The load control devices 24a-24n each include a communication unit 201 for exchanging information between the EMS 15 and different load control devices 24a-24n and a power measurement unit 202 for measuring an amount of power supply to the loads 23a-23n connected to each load control device 24a-24n.

The amount of power measured by the power measurement unit 202 is transmitted to different load control devices 24a-24n through the communication unit 201. A monitoring unit 203 for checking an operation state of a different load based on the amount of power transmitted from different load control devices 24a-24n is connected to the communication unit 201.

That is, when a control command is inputted to each load control device 24a-24n, it may not be necessarily limited to a determination that the respective loads 23a-23n connected to the control devices are in operation. If the respective loads 23a-23n are in a halted state, there is no need to increase or decrease power used by the loads based on the control command. Thus, in the present embodiment, the usage amount of power of the respective loads 23a-23n is measured by the power measurement unit 202 to thus recognize an operation state of the respective loads 23a-23n, and the recognized operation state of the respective loads 23a-23n is transmitted to the monitoring unit 203 of different load control devices 24a-24n to thus recognize the number of loads to be subjected to a control command.

Similarly, the monitoring unit 203 has a function of checking whether or not a control command has been inputted to each load control device 24a-24n thereof, and transmitting information that the control command has been inputted to different load control devices 24a-24n through the communication unit 201. Also, the monitoring unit 203 has a function of checking how many loads the control command has been inputted upon receiving from different load control devices 24a-24n information that the control command has been inputted to the different load control devices 24a-24n.

That is, when the consumer has a plurality of loads, it may not necessarily be limited to that the control command has been inputted to all the loads. The consumer may input the control command only to some of the loads managed by itself according to a certain reference or priority. When a different operation time is set to the plurality of loads, the respective loads may have a different operation time according to the number of loads to which the control command is inputted. Thus, in the present embodiment, the monitoring unit 203 is installed in the respective load control devices 24a-24n to check whether or not the control command has been inputted to a different load, thus checking the number of loads to which an operation time is set.

A calculation unit 204 for calculating a time for starting an operation of the respective loads 23a-23n is installed in each load control device 24a-24n. The communication unit 201 and the monitoring unit 203 are connected to the calculation unit 204. That is, the calculation unit 204 calculates an operation time of each load based on the number of loads to which the control command from the system management device 11 received through the communication unit 201 and the control command obtained from the monitoring unit 203 are inputted.

In this case, each calculation unit 204 of each of the load control devices 24a-24n may calculate each operation time, or the calculation unit 204 of one of the load control devices 24a-24n may calculate an operation time of every load according to a preset order, and transmit the calculation result to different load control devices 24a-24n.

A device controller 205 is connected to an output side of the calculation unit 204, and the device controller 205 operates the loads 23a-23n at a specified time according to the calculation result of the calculation unit 204.

### (2) Operation

An operation of the present embodiment will be described.

When power is excessive in the power system, or when power is insufficient in the power system, the system management operator transmits a control command requesting an increase or decrease in power demand at a designated time t0 to the consumer 14 by using the system management device 11. The control command may be transmitted the day before or at a specified hour (e.g., “Please react at a certain hour”) or may be transmitted immediately (e.g., “Please react on the spot”), but in the present embodiment, the control command is not dependent upon the timing at which the request signal is transmitted. Also, any method may be used as long as it can transfer the information, regardless of whether or not the information is transmitted through a fixed line or wirelessly.

The control command from the system management device 11 is received by the reception unit 101 of the consumer 14 and received by each load control device 24a-24n by way of the output unit 102. When the communication unit 201 in each load control device 24a-24n receives the control command, the operation time calculation unit 204 calculates an operation start time of each load 23a-23n according to a predetermined method. The operation time is calculated such that the loads 23a-23n are not operated simultaneously and time is taken for the operations of the loads to be completed.

For example, when it is defined that a time difference between a point in time at which a first load operates and a point in time at which the operations of all the loads are completed is tg, if the time difference is less than 5 minutes, a response from the power plant 12 is delayed, so from a viewpoint of the response of the power plant 12, the power plant 12 may sufficiently respond for 20 minutes. Additionally, from a viewpoint of quickly reacting to a request from the system management operator, more than 20 minutes is undesirable. Thus, tg is preferably determined to range from 5 to 20 minutes.

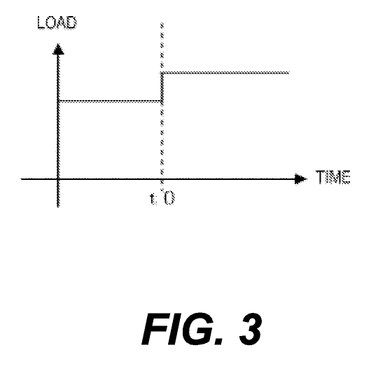

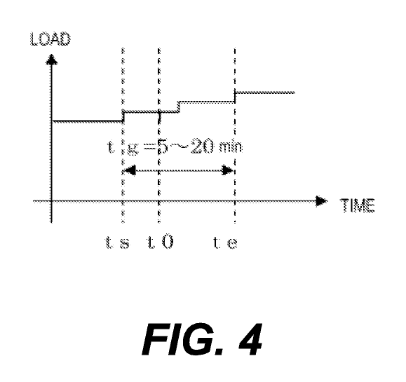

This status will be described with reference to the drawings. When all the loads are operated at the designated time t0 as in the related art, a great load change instantaneously occurs as shown in FIG. 3. In comparison, in the present embodiment, as shown in FIG. 4, the calculation unit 204 of each load control device 24a-24n calculates an operation time of each load 23a-23n such that a load change is distributed in the vicinity of the designated time t0.

The time duration tg from a point in time at which loads starts to operate to a point in time at which the operations of the loads are terminated may be equal to every consumer or may be different for each consumer. That is, the time duration tg may be 5 minutes for one consumer, while it may be 15 minutes for another consumer. The time durations may be appropriately determined according to the size of the consumer 14, a capacity of an electric device such as a load, or the like.

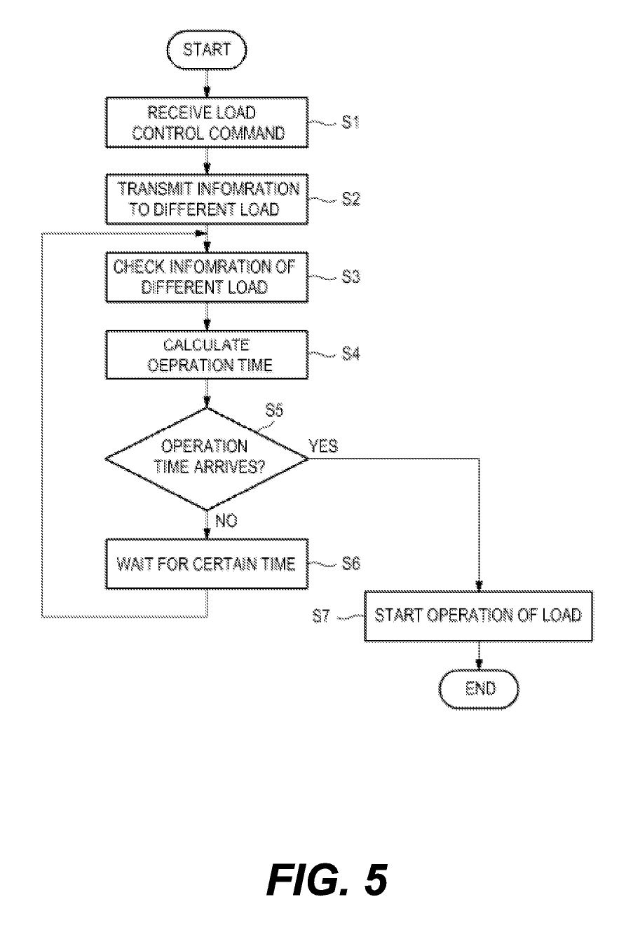

FIG. 5 is a flow chart illustrating an operation of each load control device 24a-24n connected to the loads 23a-23n. When the consumer 14 receives a control command from the system management device 11 of the power system by the reception unit 101, the consumer 14 manipulates each load control device 24a-24n based on the received control command to thus control the operation of the loads 23a-23n. Here, the consumer 14 may start an operation of a load at a time corresponding to the control command or may control an operation of a load through an advance reservation before the time corresponding to the control command.

When each load control device 24a-24n receives a control command from the consumer 14 (step 1), each load control device 24a-24n transmits the received control command to the different load control devices 24a-24n by way of the communication unit 201 (step 2). Next, each load control device 24a-24n checks other load information, recognizes the number of load control devices 24a-24n which have received the control command (step 3), and calculates an operation time of each load by the calculation unit 204 according to any one of the foregoing methods (step 4). In this case, each load control device 24a-24n may calculate the operation time, or a predetermined load control device may perform the calculation, and transmit the result to different load control devices 24a-24n.

When the operation time has not yet arrived (NO in step 5), each load control device 24a-24n waits for a certain time (step 6), and then returns to step 3 to repeatedly perform the process of checking the information of a different load, and when a different load is manipulated, each load control device 24a-24n recalculates an operation time based on the information. Thus, when the operation time has not yet arrived, whenever the number of a load control device 24a-24n to which the control command has been inputted is increased, the operation time is updated. Meanwhile, after the calculated operation time is received, when the operation time arrives (YES in step 5), the device controller 20 operates the respective loads 23a-23n based on a control command, such as a limitation of or increase in designated power from the consumer 14 (step 7).

### (3) Method of Calculating Operation Time

Next, a method of calculating an operation time by the calculation unit 204 in order to prevent the loads 23a-23n from operating simultaneously will be described. Calculation of an operation time is performed by the calculation unit 204 of each load control device 24a-24n. Here, for a simple description, it is assumed that a time at which an operation of a first load starts is ts, a time at which operation of all the loads are completed is te, and a time difference between ts and te is tg. As a calculation method, the following pattern may be employed.

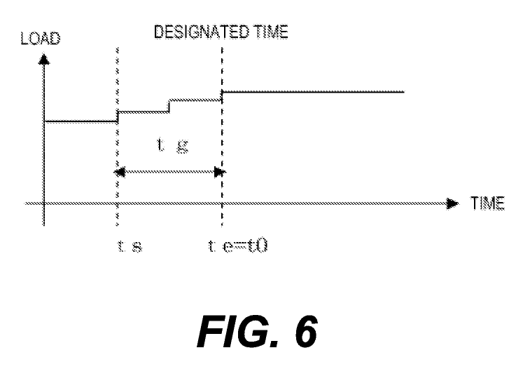

(a) As shown in FIG. 6, operation of all the target loads are completed up to a time t0 designated by the management operator of the power system. In this case, te is t0 and ts is faster than t0 by tg.

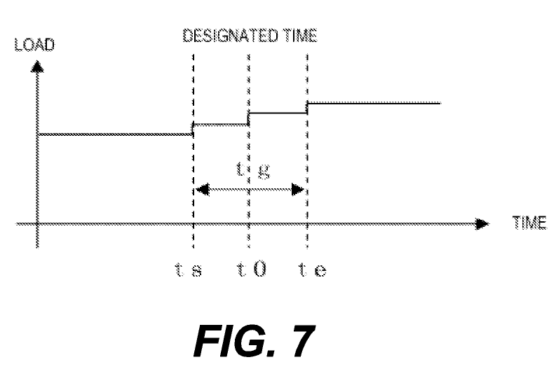

(b) As shown in FIG. 7, the operation of all the target loads are completed within tg before and after a time designated by the management operator of the power system. In this case, ts<t0<te, and a time difference between te and ts is tg.

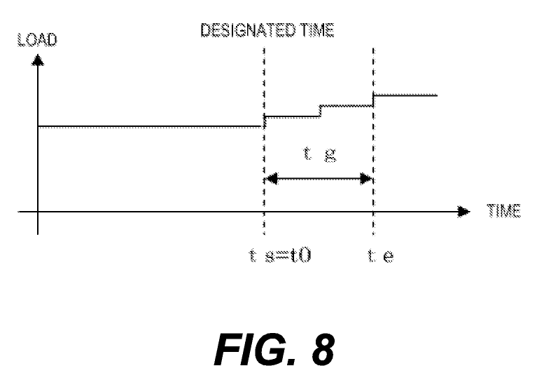

(c) As shown in FIG. 8, an operation of the load starts from a time designated by the management operator of the power system. In this case, ts=t0, and te is slower than t0 by tg.

In the present embodiment, any method among the foregoing three patterns may be employed. Also, a certain one type of the patterns in FIGS. 6 to 8 is not limitedly applied to all consumers. A plurality of types of patterns may be combined to be implemented such that a pattern as shown in FIG. 6 is applied to a certain consumer while a pattern as shown in FIG. 7 is applied to another certain consumer.

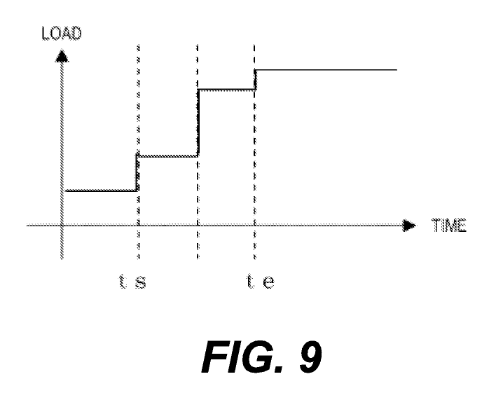

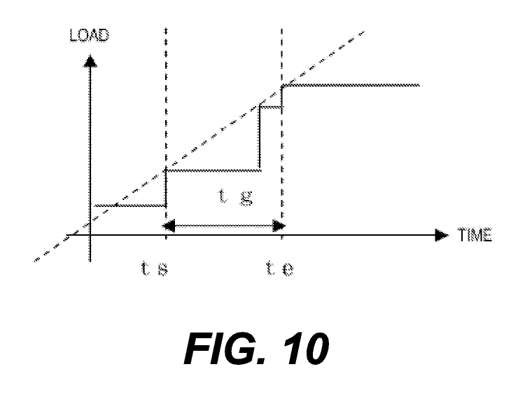

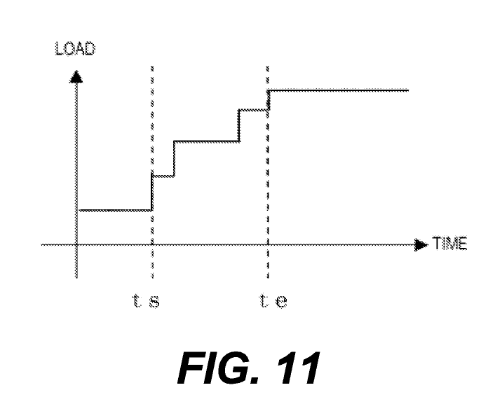

As for a time interval for the second load, and for loads thereafter, there may be a method of operating the loads at equal intervals from the operation start/end time and the number of manipulation target loads as shown in FIG. 9, a method of making linear variations of electricity demand by device operations as shown in FIG. 10, or a method of operating the loads completely randomly as shown in FIG. 11.

When there is one load, it may be operated at a certain time during tg in FIGS. 6 to 8, and when there are two loads, they may be allocated to a start time is and an end time te, or any of them may be moved randomly. However, the present disclosure is not limited to the foregoing methods and any method may be employed as long as it prevents the loads from being operated simultaneously.

In order to calculate the operation time illustrated in FIG. 10, a difference Pi of power following the operation of each load and a time width of the operation are used. Meanwhile, regarding a difference of power following the operation of a load, which is changed according to a temperature setting by an air conditioner or the like, the difference may be a difference before and after a response when a temperature setting is changed based on a command. The difference of power may be transmitted to a different load when information is transmitted to the different load, or may be previously registered to a different load.

The operation time is calculated by Eqs. (1) and (2) shown below.

tg: a time duration from a time at which an operation starts to a time at which the operation ends

t: an operation time (a time at which response starts)

Pi: a difference (i is the number of a load) of power following an operation of a load i

(First load)

t=0 Eq. (1)

(Second load to ith load)

$$t = \frac{{\sum }_{i = 2}^{n} {P}_{i}}{{\sum }_{i = 2}^{N} {P}_{i}} \times tg \qquad Eq . ( 2 )$$

The foregoing t is a time at which a response starts. As for an actual time, when the case in which a time is 12:00 and t=5, which are designated according to the method of FIG. 7 is taken as an example, the load operates at a time which is obtained by adding t to 12:00, i.e., 12:05.

The calculation method in the present embodiment is not limited to FIGS. 9 to 11 or Eqs. (1) and (2), and any method may be employed as long as it can obtain the same results.

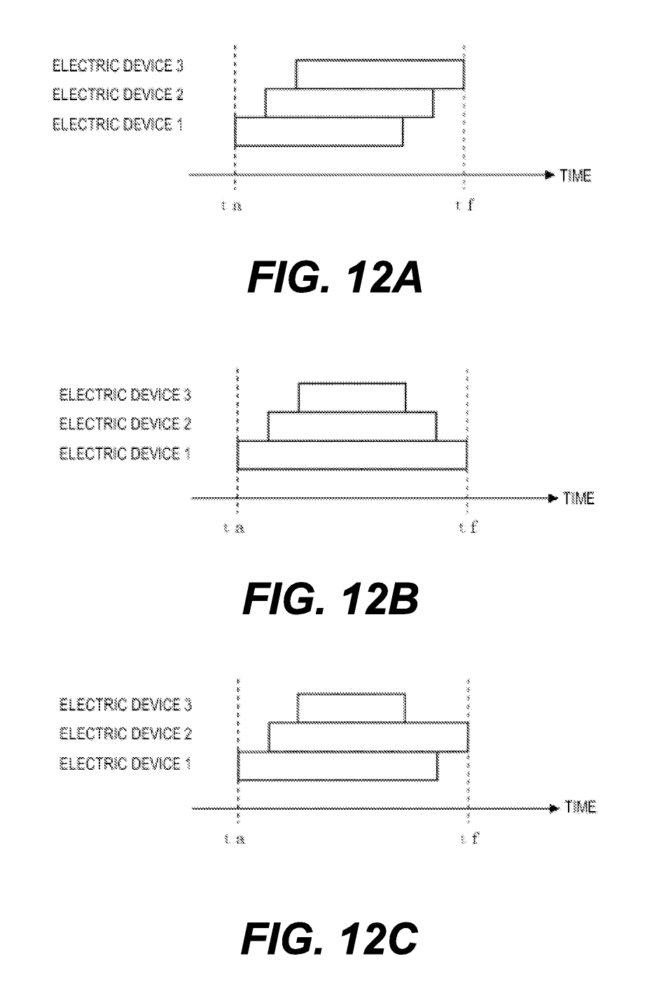

In a state in which each load is manipulated according to the command from the power system management operator, an operation opposite to the command is required, that is, when an operation of a load starts according to a request for increasing power consumption, the operation is necessarily terminated. As for order of the opposite operation, the opposite operations may be performed in the order in which the operations start as shown in FIG. 12A, the opposite operations may be performed in reverse order to the order in which the operations start as shown in FIG. 12A, or the reverse operations may be performed in a random order, regardless of order as shown in FIG. 12C.

In the case of the method of FIG. 12A, all the loads respond to the same time and request. In the case of the method of FIG. 12B, priority level for responding to a request may be set, and this method is valid for a device which has a low priority level with respect to a response and which wants to respond within a short time.

The foregoing respective calculation methods are examples of the present embodiment and the present disclosure is not limited to the respective methods; any method may be employed as long as it can obtain the same results. For example, loads to be operated in advance, operation order thereof, and operation intervals are determined, and a consumer inputs a control command to a control device of a first load. Thereafter, when a different load control device detects that the first load starts to operate, by the monitoring unit 203, the second or subsequent load may automatically operate.

### (Effect)

According to the present embodiment, as shown in FIGS. 9 to 11, the loads are prevented from operating simultaneously the instant, or immediately thereafter, a designated time arrives; electricity demand may be reduced to a variation with which the plant 12 managed and operated by the system management device 11 for supplying electricity to the power system 13 can sufficiently respond; and a load change can be restrained to below coordination of an electric generator, such that a degradation of power quality can be restrained.

### 2. Second Embodiment

### (Configuration)

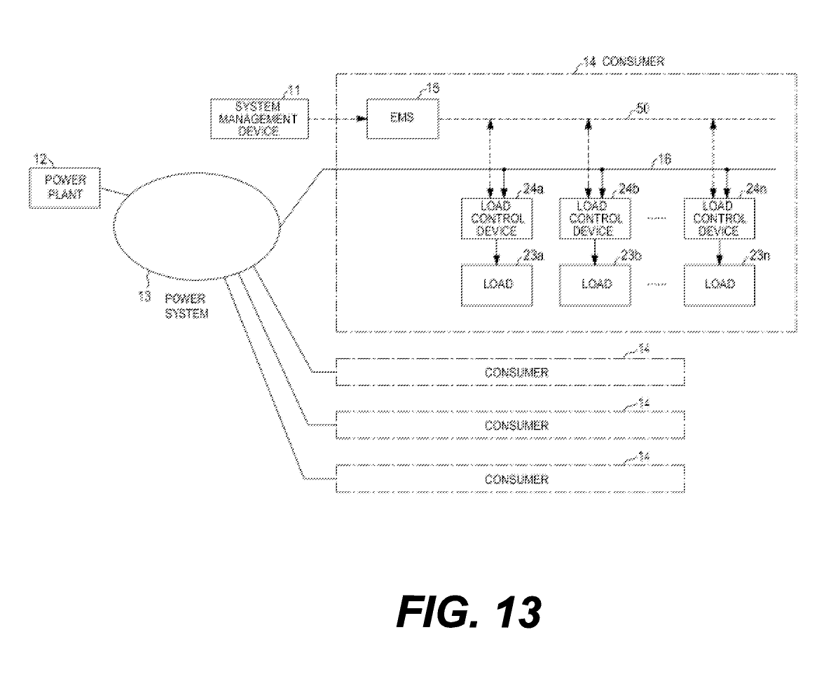

FIG. 13 is a block diagram showing an overall configuration of a second embodiment of the present disclosure.

In the present embodiment, the consumer 14 includes the EMS 15 and communicates with the load control devices 24a-24n of the respective loads 23a-23n from the system management device 11 and the EMS 15.

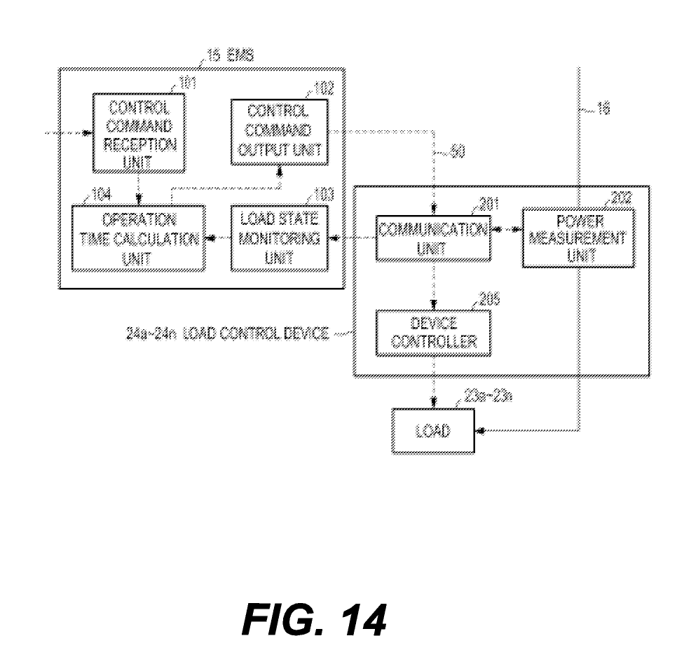

As shown in FIG. 14, the EMS 15 according to the present embodiment includes a monitoring unit 103 for monitoring an operation state of different loads 23a-23n and a calculation unit 104 for calculating an operation time of each load 23a-23n, in addition to the reception unit 101 and the output unit 102 for a control command installed in the first embodiment. That is, in the present embodiment, the monitoring unit 203 and the calculation unit 204, which are installed in each load control device 24a-24n installed in the first embodiment, are integrated into the EMS 15.

### (Operation)

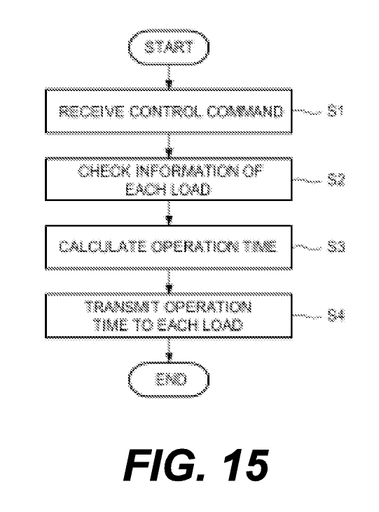

The operation of the present embodiment will be described with reference to the flow chart illustrated in FIG. 15. In the present embodiment, a control command for requesting an increase or decrease in power demand is transmitted to the EMS 15 of the consumer 14 from the system management operator. The EMS 15 receives the command by the receiving unit 101 (step 1) and checks an operation state of each load 23a-23n by the monitoring unit 203 (step 2). Thereafter, the calculation unit 104 calculates an operation time by any one of the various methods as described above in the first embodiment (step 3). The operation time of each load 23a-23n as a calculation result of the calculation unit 104 is transmitted to each load control device 24a-24n by way of the output unit 102 (step 4).

Meanwhile, when the EMS 15 constantly recognizes an operation state of each load 23a-23n, “checking of information of each load” in step 2 may be eliminated.

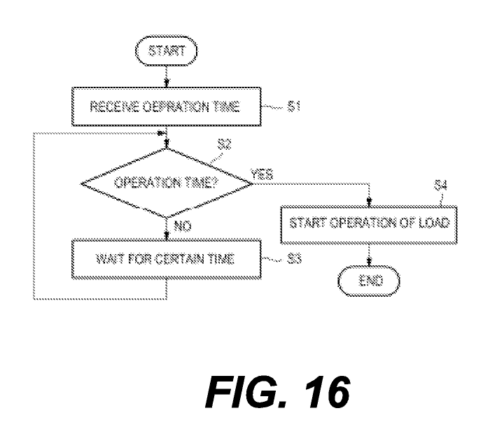

Next, an operation of each load control device 24a-24n will be described with reference to FIG. 16.

Each load control device 24a-24n receives an operation time thereof by the communication unit 201 (step 1). When an operation time has not yet arrived (NO in step 2), each load control device 24a-24n waits for a certain time (step 3), and then, the process returns to step 2.

In the interim, the EMS 15 repeatedly performs the process of checking information regarding a different load again, and when a different load receives a manipulation, the EMS 15 recalculates an operation time based on the information. Thus, if the operation time does not arrive yet, the operation time is updated whenever the number of load control device 24a-24n to which a control command is input is increased. This is the same as the first embodiment. However, when the EMS 15 recognizes which of the loads 23a-23n is a control target in advance, since the number of loads is not changed, an operation time of each load 23a-23n is also determined by an initial calculation. In this case, each load control device 24a-24n waits until the initially received operation time arrives.

A load as a control target may be registered in advance in the EMS 15 and the same load may be a control target each time, or a target load may be checked whenever a control command is received.

Meanwhile, after the operation time calculated by the EMS 15 is received, when the operation time arrives (YES in step 2), each load control device 24a-24n operates the loads 23a-23n according to a control command such as a limitation or an increase of designated power in the consumer 14 by the device controller 205 (step 4).

### (Effect)

According to the present embodiment, like the first embodiment, the loads are prevented from operating simultaneously the instant, or immediately thereafter, the designated time arrives. In addition, compared to the first embodiment, the configuration of each load control device 24a-24n is simplified and it is not required that each load control device 24a-24n calculates an operation time and transmits the calculation result to different load control devices 24a-24n. Also, since automatic controlling is performed by the EMS 15, inputting a control command to each load control device 24a-24n by the consumer 14 is not necessary, and thus, the operation of each load 23a-23n can be reliably performed at an appropriate timing.

### 3. Third Embodiment

### (Configuration)

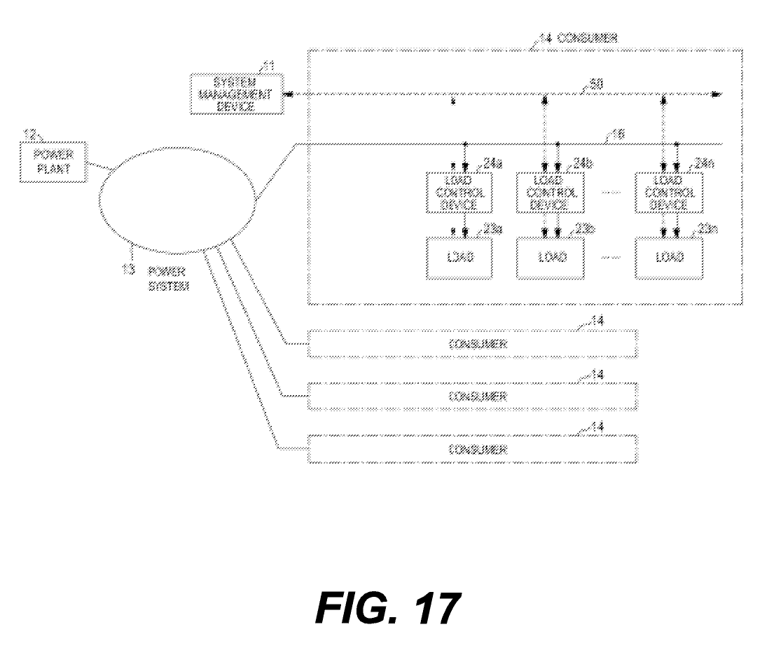

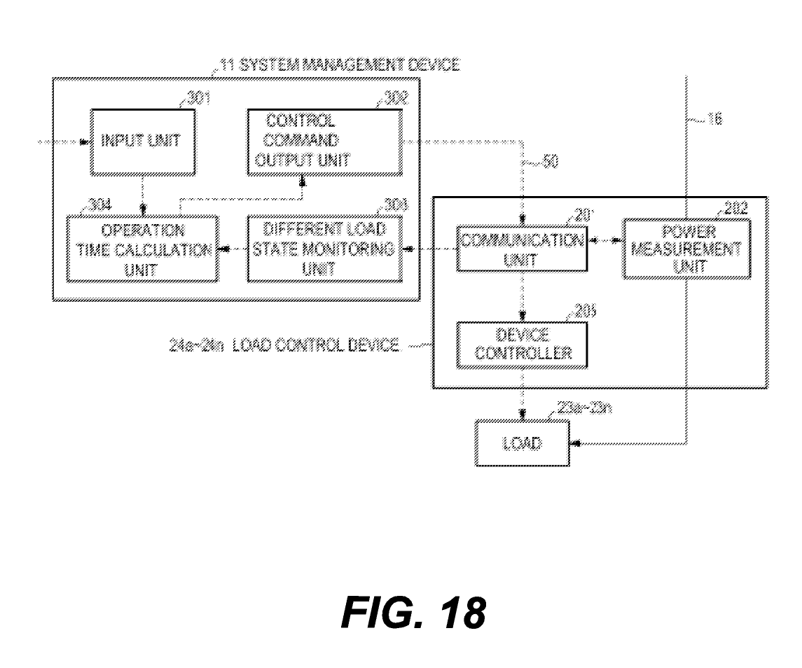

A third embodiment will be described with reference to FIGS. 17 and 18. In the third embodiment, an operation time calculation unit of each load 23a-23n is installed in the system management device 11. Thus, as shown in FIG. 17, the system management device 11 is connected to each load control device 24a-24n of the consumer 14 by the communication line 50, and each consumer 14 does not have an EMS 15 as in the second embodiment.

As shown in FIG. 18, the system management device 11 of the present embodiment includes a monitoring unit 303 for monitoring an operation state of each load control device 24a-24n of each consumer and a calculation unit 304 for calculating an operation time of each load 23a-23n, in addition to the input unit 301 and the output unit 302 of a control command. That is, in the present embodiment, the monitoring unit 203 and the calculation unit 204 installed in each load control device 24a-24n in the first embodiment are integrated in the system management device 11.

### (Operation)

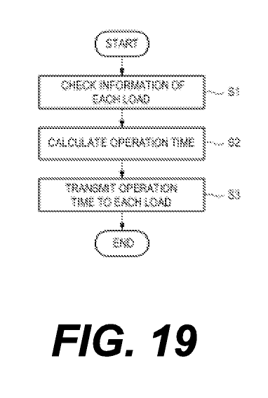

An operation of the present embodiment will be described with reference to a flow chart illustrated in FIG. 19. In the present embodiment, when a control command requesting an increase or decrease of power demand is inputted to the input unit 301 of the system management device 11 from the system management operator, the system management device 11 checks information regarding each load 23a-23n in the load state monitoring unit 303 (step 1).

That is, when information regarding which of the loads 23a-23n the consumer 14 is to execute a control command, information regarding what order the consumer 14 operates the loads, and the like are stored in each load control device 24a-24n, such information is obtained from each load control device 24a-24n. Simultaneously, an operation state of each load 23a-23n is recognized from the power measurement unit 202 installed in each load control device 24a-24n. In this case, when such information has been previously transmitted to the system management device 11 from each consumer 14, “checking of information of each load” in step 1 may be eliminated.

After the state of each load 23a-23n is checked, the calculation unit 304 of the system management device 11 calculates an operation time of each load 23a-23n by any one of the various methods as described above in the first embodiment (step 2). The calculation result obtained by the calculation unit 304 is transmitted to each load control device 24a-24n by way of the output unit 302 (step 3).

Upon receipt of the result, each load control device 24a-24n executes an operation such as decreasing or increasing power at a designated time with respect to each load 23a-23n managed by itself. In this case, the process is the same as the flow chart illustrated in FIG. 16 of the second embodiment.

In the present embodiment, processing without consideration of the operation status of each load 23a-23n may also be possible. In this case, the “checking of information regarding each load” described in FIG. 19 is omitted, and an operation time is calculated on the assumption that all the loads as requested targets are stopped or in operation.

For example, when a command for increasing power consumption is issued, an operation time is calculated on the assumption that the loads 23a-23n as requested targets are all stopped. Then, the result is transmitted to the loads 23a-23n, and when a target load is stopped, the load transitions from the stop state to an operation state in response to the request signal, and when a target load is in operation, a response is not made despite receiving a request signal, since the target load is already in operation.

According to the present embodiment, besides the obtaining of the effect like that of the first embodiment, the configuration of the respective loads and control devices is simplified more than those of the first embodiment. Also, there is no need to install the EMS 15 in every consumer. In addition, since all information and the calculation unit is integrated in the system management device 11 and every load is operated according to the intention of the system management operator, a degradation of power quality can be further restrained.

### 4. Fourth Embodiment

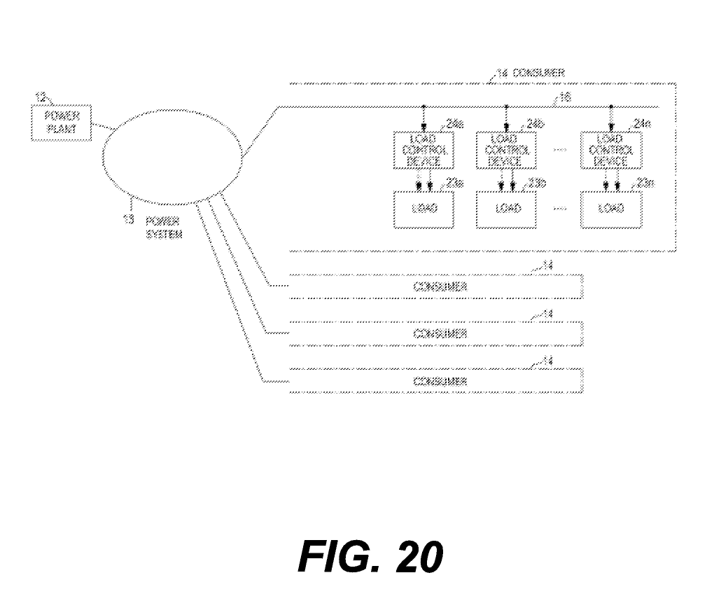

A fourth embodiment will be described with reference to FIG. 20. In the present embodiment, the system management device 11 and the EMS 15 are eliminated, and a control command from the system management operator is transmitted to the consumer 14 through a phone, mail, facsimile, written notification, such as documents, or the like, and based on the control command, the consumer 14 directly inputs a control command to each load control device 24a-24n.

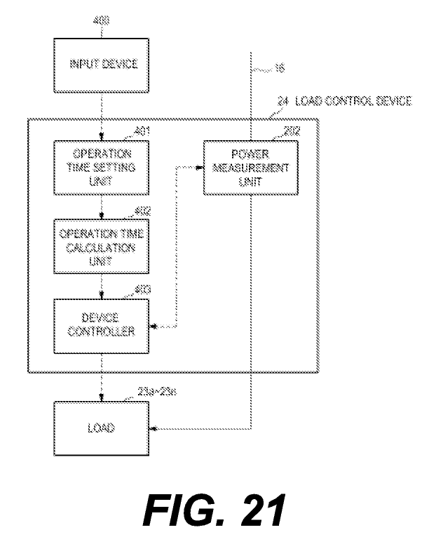

As shown in FIG. 21, each load control device 24a-24n of the present embodiment is connected to an input device 400, such as a keyboard, a storage device, etc., manipulated by the consumer 14. Each load control device 24a-24n includes an operation time setting unit 401 connected to the input device 400 and an operation time calculation unit 402 connected to the operation time setting unit 401. When the consumer 14 inputs a designated time in a control command to the setting unit 401, the calculation time 402 calculates an operation time of each load 23a-23n based on the designated time.

As a calculation method of the calculation unit 402, a method that does not refer to a state of a different load, among the calculation methods described in the respective embodiments, may be used. For example, a method of setting a random number in each device until a product is launched, and employing a time obtained by adding the random number to an operation designated time, as an operation time, may be used. Also, an operation time unique to a load may be set until a product is launched without setting it to the consumer. In this case, the set operation time is distributed within tg so as to avoid simultaneous operations. Further, the present embodiment is not limited to the foregoing method and any method may be employed as long as a set value is automatically corrected to prevent simultaneous operations.

### (Operation and Effect)

In the present embodiment, an operation time is set in advance in each load 23a-23n, and when the operation time arrives, each load 23a-23n is operated. In this case, the time set by the consumer 14 is automatically corrected by the calculation unit 403 installed in each load control device 24a-24n such that it is different for each load 23a-23n. Accordingly, the plurality of loads can be prevented from operating simultaneously.

This embodiment is valid when operated, in particular, at a determined day and time, such as 11:00 to 13:00 on weekdays. In addition, according to the present embodiment, the system configuration is simpler in comparison to the foregoing respective embodiments.

### 5. Fifth Embodiment

### (Configuration)

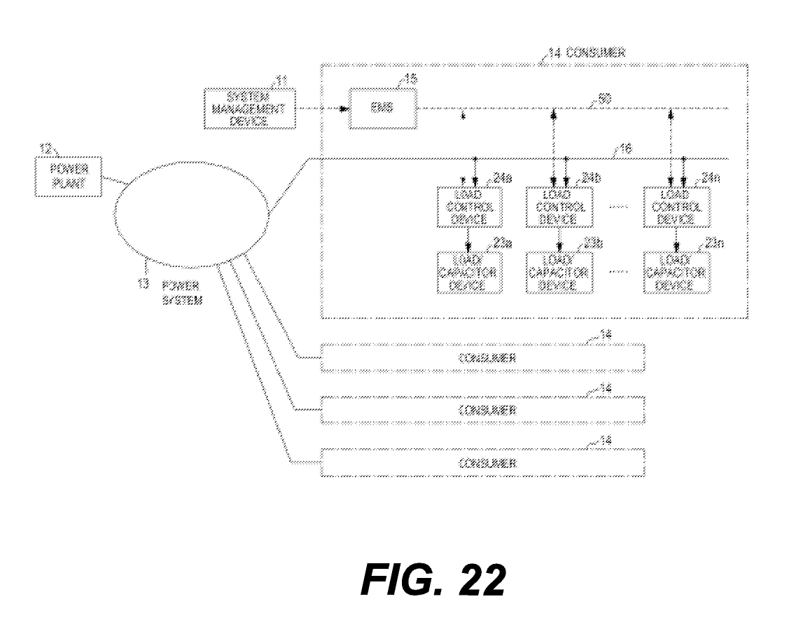

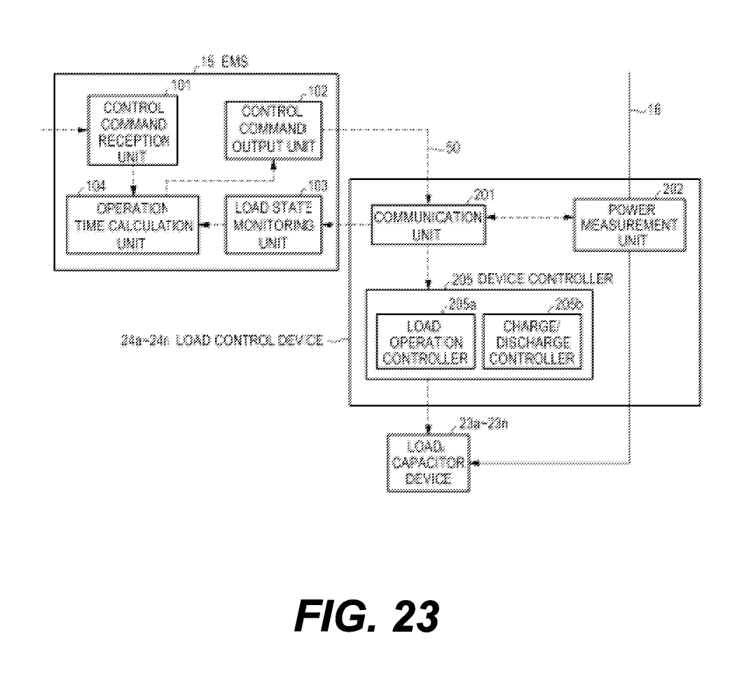

A fifth embodiment will be described with reference to FIGS. 22 to 25. In the present embodiment, some or all of the loads 23a-23n are configured as loads and capacitor devices for storing or discharging power in any one of the first to fourth embodiments. FIG. 22 shows an application of the fifth embodiment to the configuration in which the EMS 15 of the second embodiment is installed in each consumer 14, but the fifth embodiment is not limited to FIG. 22.

The load and capacitor devices may include an emergency capacitor device installed in homes, hospitals, plants or the like, or a capacitor device which serves as a load in case of charging and outputs power charged in a battery to a consumer or a system in case of discharging, such as an electric automotive, or houses or plants having a photovoltaic generating panel and a capacitor device.

In the fifth embodiment, the power measurement unit 202 may measure a power usage amount of the load and capacitor device, an amount of charging or discharging power, or a power storage amount of the capacitor device, as necessary. Also, the device controller 205 of each load control device 24a-24n includes a load operation controller 205a and a charge/discharge controller 205b of the capacitor device. The charge/discharge controller 205 controls the capacitor device based on each operation time set by the calculation unit 104 of the EMS 15 as a start point, as follows.

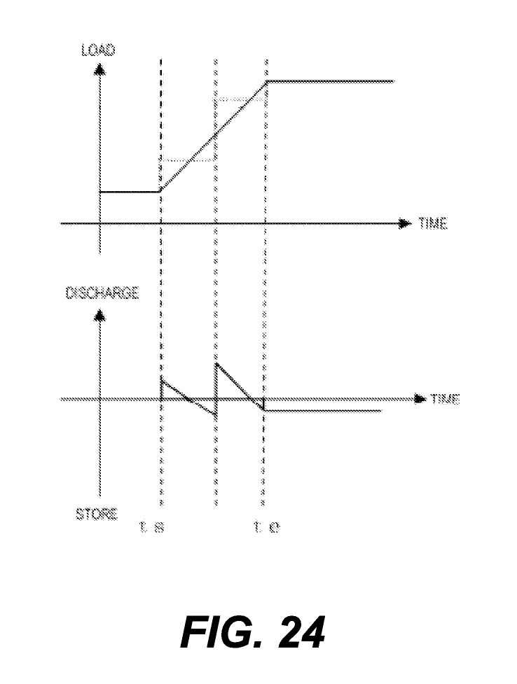

(1) As shown in FIG. 24, in order to make a gentle power flow of connection points with the power system 13 from ts to te, an amount of discharge of the capacitor device is controlled such that the amount of discharge is increased when each load 23a-23n starts to operate, and then, sequentially reduced when subsequent loads start to operate to obtain an uneven saw-tooth stripe shape from ts to te.

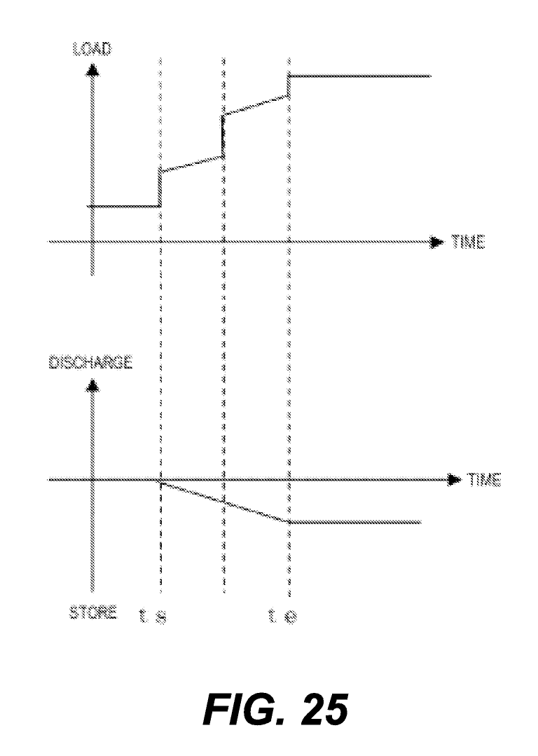

(2) As shown in FIG. 25, only an output of the capacitor device is gently reduced between ts at which the first load starts to operate and te at which an operation of the last load is completed. In such case, a power flow at the connection points has a stepwise shape from ts to te.

### (Operation and Effect)

According to the present embodiment, an operation start time of each load 23a-23n can be slightly moved, and the following operational effects can be obtained by controlling charging and discharging of the capacitor device.

For example, according to (1), a difference between power demand changing stepwise due to operations of different devices and an output command value having a gentle flow of connection points can be supplemented by an output of a device that can store or discharge power, whereby the flow of the connection points can have a sloped shape. In (2), by allowing only an output of a device that can store or discharge power to have a sloped shape, a variation due to the device that can store or discharge power can be reduced.

As described above, according to the present embodiment, the capacitor device capable of storing or discharging power can be used to further restrain a change, in addition to the effects of the foregoing respective embodiments.

### 6. Sixth Embodiment

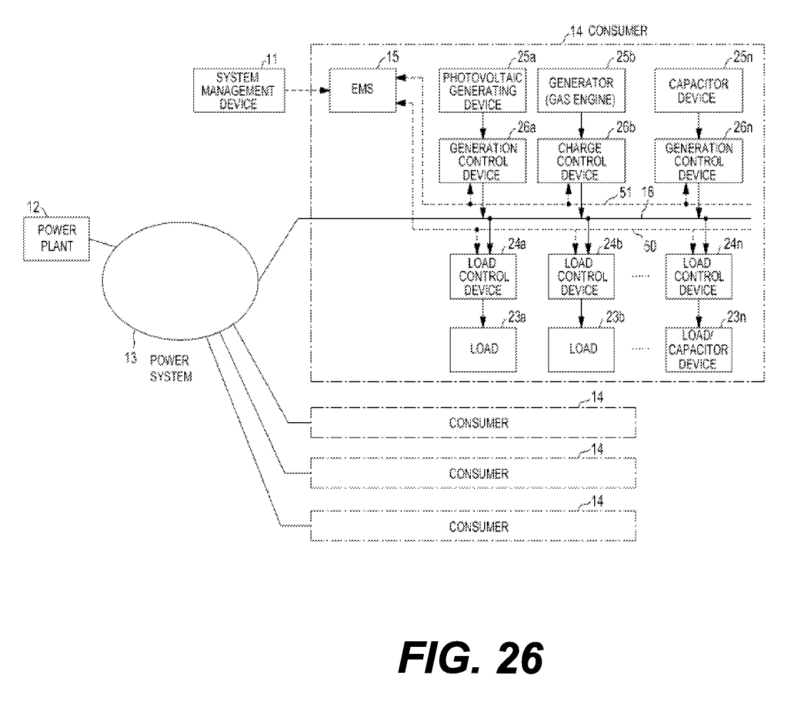

A sixth embodiment will be described with reference to FIGS. 26 to 29. In this embodiment, a generating device is installed by adding loads 23a-23n to a power line 16 extending from a system 13 in any one of the first to fifth embodiments. FIG. 26 shows an application of the present embodiment to the configuration in which the EMS 15 is installed in each consumer 14, but the present embodiment is not limited to FIG. 26.

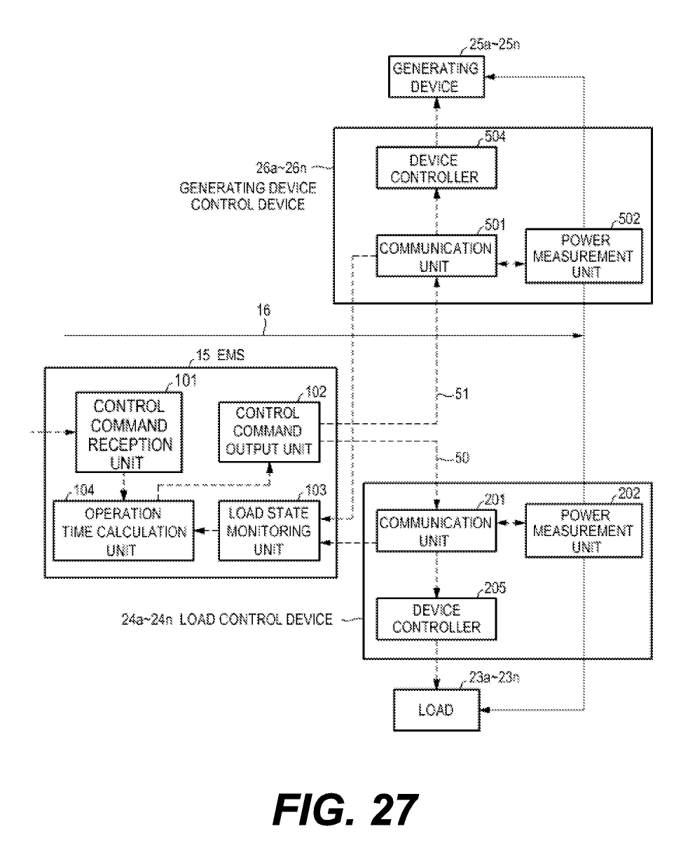

A photovoltaic generating device 25a, a gas engine generator 25b, a water-turbine generator, a wind generator, or the like may be used as the generating device. Generation control devices 26a-26n are installed in the respective generating devices 25a-25n. As shown in FIG. 27, the generating devices 25a-25n include a communication unit 501 for communicating with the EMS 15, a power measurement unit 502 for detecting an operation state of the generating devices 25a-25n, and a device controller 504. The device controller 504 controls the operation of the respective generating devices 25a-25n based on an operation time transmitted from the operation time calculation unit 104 of the EMS 15.

### (Operation and Effect)

In case of a generator in which an output can be freely changed, such as a gas engine generator or the like, a variation can be reduced by gently changing an output, like the device which can store or discharge power as described in the fifth embodiment.

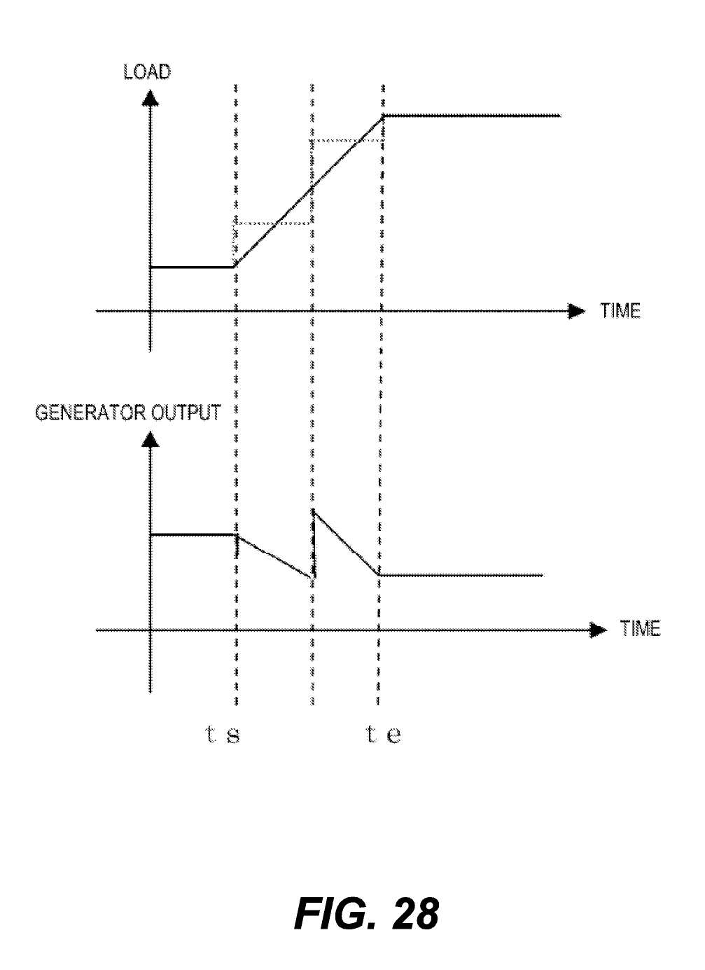

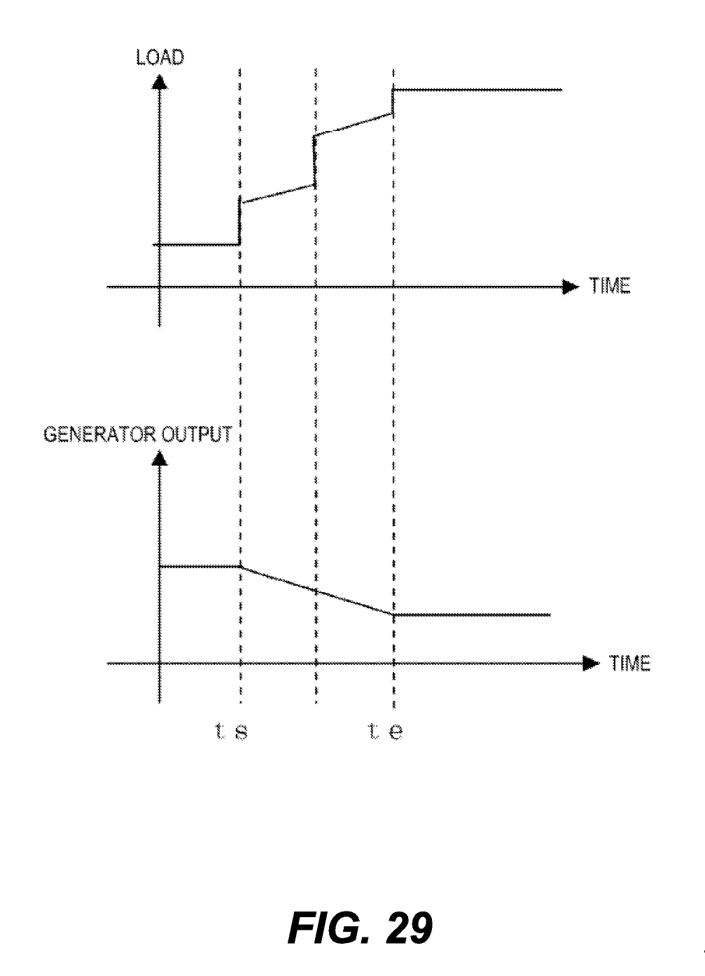

Specifically, a flow of connection points can have a sloped shape by supplementing a difference with the output command value such as the case in which the flow of the connection points is gentle, as shown in FIG. 28, by an output of the generating device, or a variation of power in case of starting an operation of decreasing or increasing a plurality of loads is reduced by making only an output of the generating device have a sloped shape as shown in FIG. 29. This may be an operation of adding a bias to the output of the device that can store or discharge power as described in the fifth embodiment.

Meanwhile, the generator whose output cannot be freely changed, like the photovoltaic generating device, basically has a movement like the loads 23a-23n described in the first to fourth embodiments. A generator whose output cannot be freely changed refers to a generator uncertain about obtaining a desired output, but even for this generator, power desired to be initially generated can be reduced through controlling. That is, in case of a combination of a device whose power consumption is increased as an operation starts or as an output is increased and a device whose supply power is reduced as an operation is stopped or an output is reduced, the devices can be simultaneously operated.

For example, when a command for increasing a load is received from the power system management operator, a new load consuming power is operated or loads are operated to increase output and, simultaneously, an output of a generator whose output cannot be freely changed is limitedly reduced. Here, in the first to fourth embodiments, a single operation is performed basically, but in case of the combination of the load consuming power and the device generating power as in the present embodiment, since variations according to operations are canceled out, they can be simultaneously manipulated.

In other words, in case of calculating an operation time, an operation time is calculated excluding the generating device, and thereafter, the device may be operated at a certain timing included in a plurality of calculated operation times. When the devices are simultaneously operated, a variation corresponding to a single operation can be reduced.

According to the present embodiment, the device for generating power can be used in addition to the effects of the respective embodiments and, thus, a more flexible system can be established.

### 7. Seventh Embodiment

### (Configuration)

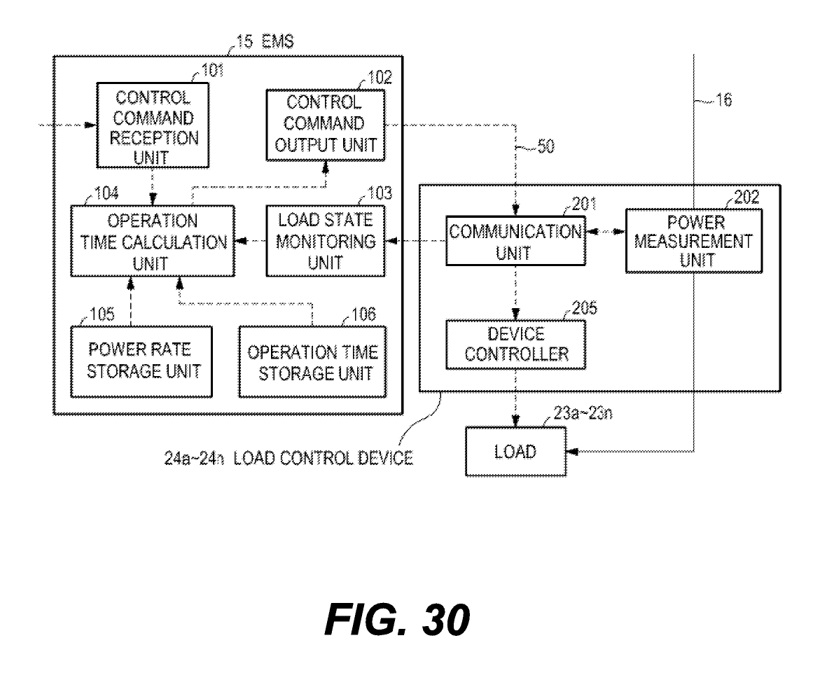

A seventh embodiment will be described with reference to FIG. 30. In the present embodiment, the operation time is calculated while considering power rates in any one of the first to sixth embodiments. FIG. 30 shows an application of the present embodiment to the configuration in which the EMS 15 is installed in each consumer 14, but the present embodiment is not limited to FIG. 30.

To this end, in the present embodiment, a power rate storage unit 105 is installed in the EMS 15, and power rates regarding the respective loads 23a-23n are stored in the storage unit 105. Since power rates are different according to a power usage time or a season, such as midnight electric power, seasonal power or the like, an operation time storage unit 106 for storing an operation schedule time of each load 23a-23n is installed. In addition, an operation time calculation unit 104 calculates an operation time of each load 23a-23n while considering a power rate and an operation time as described hereinafter, in addition to information regarding an operational state of each load 23a-23n or the presence or absence of a control command.

### (Operation and Effect)

For example, when a power rate is changed over time, a consumer may suffer from a disadvantage as a load does not operate at a scheduled time. In order to prevent this, in the present embodiment, an operation time is calculated as follows.

First, a temporary operation time is calculated according to Eqs. (1) and (2) described in the first embodiment. And it is assumed that a power rate before the time tc at which the power rate is changed is Pp, and a power rate after the tc is Pa. Here, it is assumed that five devices respond, power consumption of the loads 23a-23e is Xa-Xe, and a temporary response time is Ta-Te.

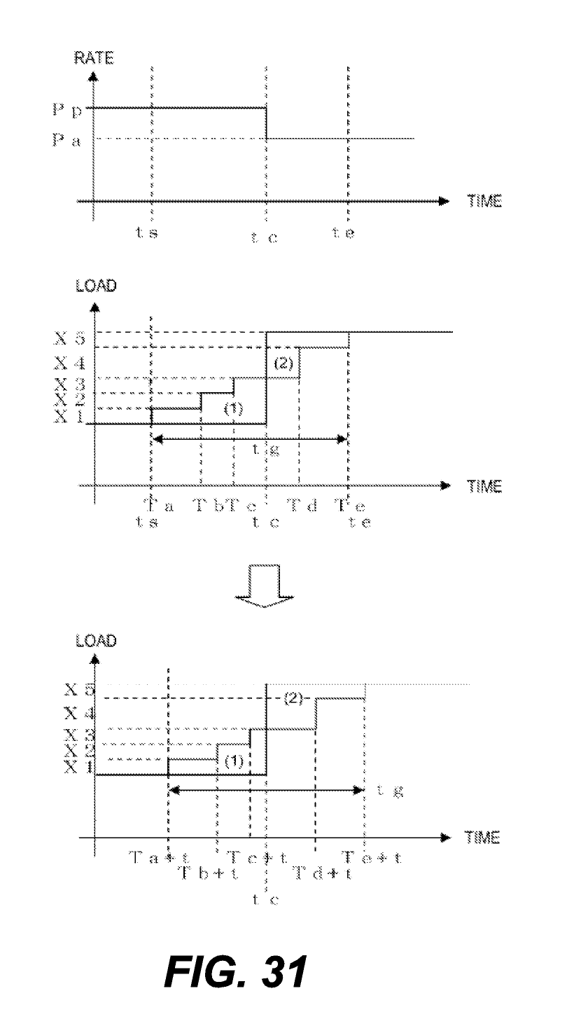

In FIG. 31, in a portion (1), the loads are operated early during a time duration in which a power rate is high, and in a portion (2), the loads are operated late during a time duration in which the power rate is low. That is, in (1), the power rate is higher than the case in which the loads are operated simultaneously, and in (2), the power rate is lower than the case in which the loads are operated simultaneously because a time duration in which the loads are operated is shortened.

The sums of power rates are equal before and after the power rates are changed, when a value obtained by multiplying Pp to the area of (1) and a value obtained by multiplying Pa to the area of (2) are equal. Thus, the difference between the two is made to 0 by delaying a response time by a time t while maintaining the time interval of the temporary response time Ta-Te.

A power rate of the device which respond before the power rate is changed may be expressed by Eq. (3) below:

$${P}_{p} \times {\sum }_{n = a}^{c} {\int }_{{T}_{n} + t}^{{t}_{c}} {X}_{n} \cdot ( {t}_{c} - ( {T}_{n} + t ) ) d t \qquad Eq . ( 3 )$$

A power rate of the device which respond after the power rate is changed may be expressed by Eq. (4) below:

$${P}_{p} \times {\sum }_{n = d}^{e} {\int }_{{T}_{n} + t}^{{t}_{c}} {X}_{n} \cdot ( {t}_{c} - ( {T}_{n} + t - {t}_{c} ) ) d t \qquad Eq . ( 4 )$$

The correction time t can be obtained by solving an equation of (3)=(4). And then, t is added to the temporary response time Ta-Te to correct it to obtain a formal response time. Also, when a load responds, the reverse operation is executed. Also, in such case, the same calculation as described above can be executed to correct a response time.

According to the foregoing method, a power rate difference is gone whenever each operation is performed, but it is also possible that a power rate difference is generated at each time as a constraint condition that a power rate difference is gone within a certain period of time like, for example, a week, and the power rate difference becomes 0 up to the last time of the period.

According to the present embodiment having the foregoing configuration, a disadvantage of paying a higher rate than a power rate determined in the related art can be avoided despite the power rate being changed over time, and the effects of the respective embodiments is also obtained.

### 8. Other Embodiments

The present disclosure is not limited to the respective embodiments but also include the following embodiments.

(1) In the foregoing respective embodiments, the present disclosure is described as a system for controlling an operation of an electric device, but a program for functioning the operation control method executed in the present system, or a computer as an operation control device of an electric device, is also an aspect of the present disclosure.

(2) When a plurality of consumers are integrated, the consumers may be grouped such that demand for power loads is equal in each group, the configuration of a power device is equal in each group, or the characteristics of the loads are equal in each group.

(3) The system management device 11, the EMS 15, the load control devices 24a-24n, and the generating devices 25a-25n may be configured to be divided as long as the same function can be obtained.

(4) The present disclosure is not limited to the foregoing embodiments, and the components may be modified to be embodied within a range that does not divert from the gist of the present disclosure in an implementation stage. Also, various inventions may be formed by appropriately combining a plurality of components disclosed in the foregoing embodiments. For example, some of the components disclosed in the embodiments may be deleted. In addition, components of other embodiments may be appropriately combined.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A system for managing power usage comprising:
an operation time calculation unit configured to calculate operation start times for increasing or decreasing power received by a plurality of electric devices based on a control command that requests an increase or decrease of power received from a power system, the start times being different for each of the electric devices, and
a plurality of control devices configured to increase or decrease power received by the plurality of electric devices at the operation start times for each of the electric devices.

2. The system of claim 1, wherein each of the control devices comprises:
a communication unit configured to exchange information with the plurality of electric devices;
an operation state monitoring unit configured to monitor an operation state of the plurality of electric devices and/or an input state of a control command of the plurality of electric devices; and
a calculation unit configured to calculate an operation time of each of the plurality of electric devices based on the information obtained from the monitoring unit and the control command.

3. The system of claim 1 further comprising an energy management device for managing an operation of the plurality of electric devices, and
wherein the energy management device comprises:
a communication unit configured to exchange information between the respective electric devices;
an operation state monitoring unit configured to monitor an operation state of the respective electric devices and/or an input state of the control command of each of the electric devices; and
a calculation unit configured to calculate an operation time of each of the electric devices based on the information obtained from the monitoring unit and the control command.

4. The system of claim 1, wherein a system management device for controlling an operation of each of the electric devices connected to the power system is installed in the power system, the system management device comprising:
a communication unit configured to exchange information with the plurality of electric devices;
an operation state monitoring unit configured to monitor an operation state of each of the plurality of electric devices and/or an input state of the control command of each of the electric devices; and
a calculation unit configured to calculate an operation time of each of the electric devices based on the information obtained from the monitoring unit and the control command.

5. The system of claim 1, wherein each of the control devices comprises:
an operation time setting unit configured to input a control command to each of the electric devices by a consumer; and
a calculation unit configured to calculate an operation time of each of the electric devices based on the control command input to the operation time setting unit.

6. The system of claim 1, wherein:
at least one of the electric devices is configured as a load and a capacitor device,
the control device comprises a load operation controller and a capacitor device operation controller,
the operation time calculation unit calculates an operation start time of the load and the capacitor device based on the control command, and
the load operation controller and the capacitor device operation controller control an operation of the load and the capacitor device based on the calculation result.

7. The system of claim 1, wherein a generating device is connected together with the electric device to the power system, and
wherein the generating device comprises a generation control device configured to control an operation of the generating device, and
the operation time calculation unit calculates an operation start time of the electric device and an operation control time of the generating device based on the control command, and an operation controller of the electric device and an operation controller of the generating control device control an operation of the electric device and the generating device based on the calculation result.

8. The system of claim 1, wherein the operation time calculation unit comprises an operation time storage unit and a power rate storage unit of each of the electric devices, and calculates an operation time of each of the electric devices based on a power rate stored in the power rate storage unit.

9. A method for controlling an electric device operation comprising a plurality of electric devices managed by a consumer associated with a power system and a plurality of control device for controlling an operation of the electric devices, the method comprising:
calculating a start time of an operation of increasing or decreasing power received from the plurality of electric devices based on a control command for requesting an increase or decrease of power received from the power system such that it is different for each of the electric devices; and
executing, by the control device of each of the electric devices, an operation of increasing or decreasing reception power at an operation start time different for each of the electric devices as a result of calculation of a calculation unit.

10. The method of claim 9, wherein at least one of the electric devices is configured as a load and a capacitor device, the method further comprising:
calculating an operation start time of the load and the capacitor device based on the control command by the operation time calculation unit; and
controlling an operation of the load and the capacitor device based on the calculation result by a load operation controller and a capacitor device operation controller.

11. The method of claim 9, wherein a generating device is connected together with the electric device to the power system, and comprises a generation control device configured to control an operation of the generating device, the method further comprising:
calculating an operation start time of the electric device and an operation control time of the generating device based on the control command by the operation time calculation unit; and
controlling an operation of the electric device and the generating device based on the calculation result by an operation controller of the electric device and the operation controller of the generation control device.

12. The method of claim 9, wherein the operation time calculation unit comprises an operation time storage unit and a power rate storage unit of each of the electric devices, and
wherein the method comprises calculating an operation time of each of the electric devices based on a power rate stored in the power rate storage unit by the calculation unit.

13. A method for controlling the frequency of electricity on an electrical system comprising:
calculating a start time for increasing or decreasing power received from a plurality of electric devices based on a control command for requesting an increase or decrease of power received from a power system such that the power received is different for each of the electric devices; and
executing, by a control device of each of the electric devices, an operation of increasing or decreasing reception power at an operation start time different for each of the electric devices as a result of calculation of a calculation unit.

14. The method of claim 13, wherein at least one of the electric devices is configured as a load and a capacitor device, the method further comprising:
calculating an operation start time of the load and the capacitor device based on the control command by the operation time calculation unit; and
controlling an operation of the load and the capacitor device based on the calculation result by a load operation controller and a capacitor device operation controller.

15. The method of claim 13, wherein a generating device is connected together with the electric device to the power system, and comprises a generation control device configured to control an operation of the generating device, the method further comprising:
calculating an operation start time of the electric device and an operation control time of the generating device based on the control command by the operation time calculation unit; and
controlling an operation of the electric device and the generating device based on the calculation result by an operation controller of the electric device and the operation controller of the generation control device.

16. The method of claim 13, wherein the operation time calculation unit comprises an operation time storage unit and a power rate storage unit of each of the electric devices, and
wherein the method comprises calculating an operation time of each of the electric devices based on a power rate stored in the power rate storage unit by the calculation unit.
